(19) United States
(12) Patent Application Publication
(10) Pub. No.: US 2016/0313516 A1
(43) Pub. Date: Oct. 27, 2016

(54) APPARATUS FOR COMBINING OUTPUTS OF FIBER-LASERS

(71) Applicant: Coherent, Inc., Santa Clara, CA (US)

(72) Inventors: Sergei GOVORKOV, Los Altos, CA (US); Douglas W. Anthon, El Cerrito, CA (US); Andrea Caprara, Palo Alto, CA (US)

(21) Appl. No.: 14/691,857

(22) Filed: Apr. 21, 2015

(51) Int. Cl. G02B 6/42; G02B 27/12

(52) U.S. Cl. CPC G02B 6/4212; G02B 27/123

(57) ABSTRACT

Diverging beams from three fiber-lasers are collimated by a three-segment composite lens. The collimated beams propagate parallel to each other to a single focusing lens that focuses the collimated beams into a transport fiber.

### TECHNICAL FIELD OF THE INVENTION

The present invention relates in general to high-power continuous wave (CW) fiber-lasers. The invention relates in particular to directing the outputs of a plurality of such lasers into a single transport fiber.

### DISCUSSION OF BACKGROUND ART

CW fiber-lasers are rapidly replacing solid-state lasers for laser machining operations, such as metal cutting, where high CW power, for example several kilowatts (kW), is required. CW fiber lasers are commercially available with power output up to about 5 kW.

Such high-power fiber-laser are very complex and require sophisticated arrangements for providing pump-radiation and coupling the pump radiation into a gain-fiber. Gain-fibers must be specially formulated to resist damage through photo-darkening, and resonant-cavity mirrors must be arranged to avoid instability of the laser output through nonlinear effects. A detailed description of such arrangements is provided in U.S. Pre-grant Publication No. 20130028276, the complete disclosure of which is hereby incorporated herein by reference.

Many of the above discussed complexities and sophisticated arrangements can be avoided if the output power of a CW fiber-laser is limited to about 1 kW. Were a means available to combine the outputs of a plurality of such 1 kW lasers into single transport fiber, without significant power loss or degradation of beam quality, high-power cutting operations could be performed without the need for a multi-kW fiber-laser.

### SUMMARY OF THE INVENTION

In one aspect, optical apparatus in accordance with the present invention comprises a plurality N of fiber lasers each thereof emitting a diverging beam having first numerical aperture, and a transport optical fiber. The apparatus includes a collimator assembly including N juxtaposed lens-segments each thereof having an optical-axis and arranged about a geometric axis of collimator assembly. The optical-axes of the lens segments and the geometric-axis of the collimator assembly are parallel to each other. The optical-axes of the lens-segments are arranged on a circle having a radius centered on the geometric-axis of the collimator assembly. Each of the optical fibers is aligned with the optical axis of a corresponding one of the lens segments such that the diverging beams of the fiber lasers are collimated by the collimator assembly. A focusing lens is arranged to focus the collimated beams combined into the transport optical fiber, with combined focused beams having a second numerical aperture.

### BRIEF DESCRIPTION OF THE DRAWINGS

The accompanying drawings, which are incorporated in and constitute a part of the specification, schematically illustrate a preferred embodiment of the present invention, and together with the general description given above and the detailed description of the preferred embodiment given below, serve to explain principles of the present invention.

FIG. 1 is a three-dimensional view schematically illustrating a preferred embodiment of beam-combiner apparatus in accordance with the present invention for directing the output of three fiber-lasers into a transport fiber, the apparatus including three juxtaposed lens-segments, for collimating the output arranged to collimate the outputs of the three fiber lasers, and a single lens arranged to focus the collimated outputs into a single transport fiber, the three lens segments having optical axes thereof displaced by a predetermined distance from a geometric center of the juxtaposed lens segments.

FIG. 2 is an end elevation view schematically illustrating details of an arrangement of the three juxtaposed lens segments of FIG. 1.

FIG. 3 is a side elevation view schematically illustrating general dimensions and beam-parameters in the beam-combiner apparatus of FIG. 1.

FIG. 4 is a graph schematically illustrating coupling losses, and output numerical aperture (NA) and beam-parameter product (BPP) ratio of combined beams, as a function of the displacement of the optic axes and the NA of individual focused beams in the combination thereof.

FIG. 5 is a graph similar to the graph of FIG. 4 but calculated for an example of combining the outputs of 4 fiber lasers using a four-segment lens.

### DETAILED DESCRIPTION OF THE INVENTION

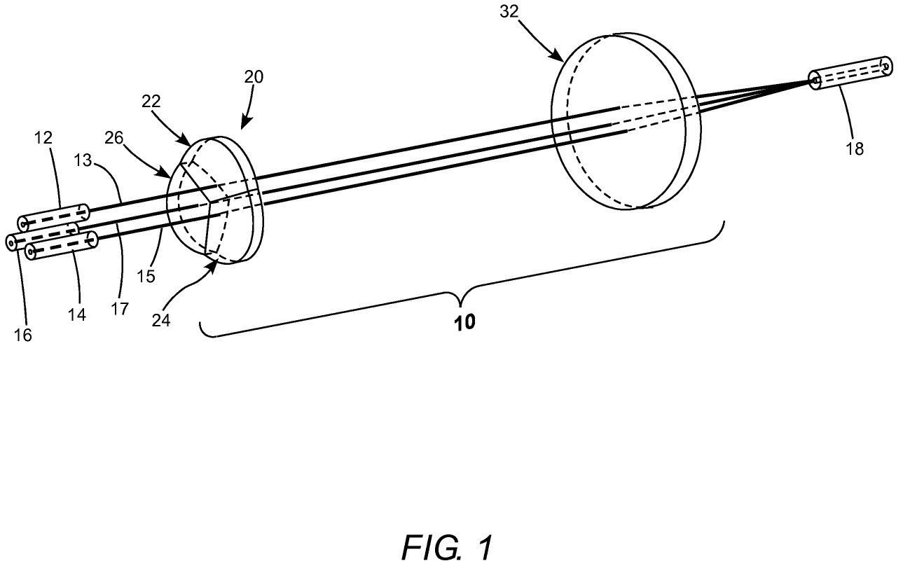

Referring now to the drawings, FIG. 1 schematically illustrates a preferred embodiment of beam-combining optical apparatus in accordance with the present invention. Apparatus 10 is arranged to focus output beams of three fiber-lasers 12, 14, and 16 into a single transport optical fiber. The output beams of lasers 12, 14, 1nd 16 are designated respectively as beams 13, 15, and 17. These individual beams are referred to hereinafter as “beamlets”. In the drawing of FIG. 1, only axial rays of the beamlets are depicted for simplicity of illustration.

Apparatus 10 includes a composite lens 20, including three juxtaposed lens segments 22, 24, and 26, each having positive optical power, which are arranged to collimate the output beamlets of fibers 12, 14, and 16 respectively. The collimated beamlets are each focused by a positive (focusing) lens 32 into optical fiber 18. In the drawing of FIG. 1, the composite lens and the focusing lens, and the spacing thereof from each other and from the fiber lasers and the transport fiber, are depicted proportionately to scale for one example of the inventive apparatus.

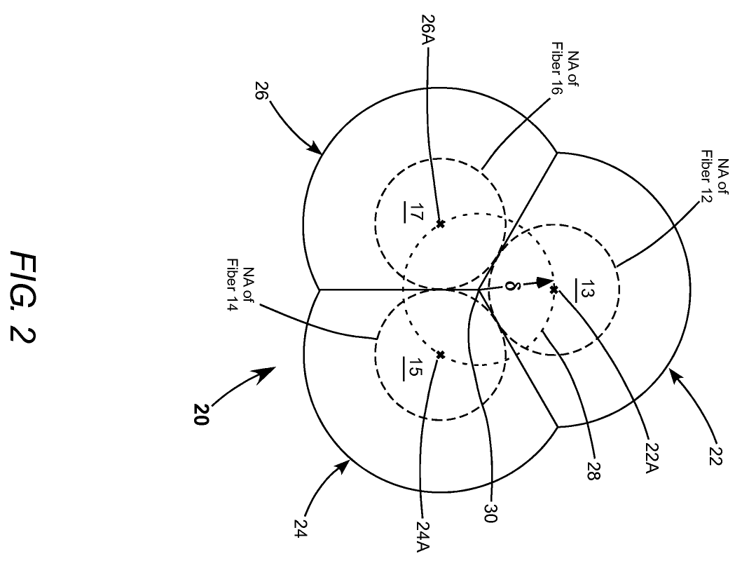

FIG. 2 schematically illustrates details of composite lens 20 relative to beamlets 13, 15, and 17. Optical axes 22A, 24A, and 26A of segments 22, 24, and 26, respectively are located on a circle 28 indicated by a short-dashed line. Circle 28 has radius δ about the geometrical center 30 (geometric axis) of composite lens 20. This radius is referred to hereinafter as the displacement of the optic-axes of the lens segments. Long-dashed circles represent the projection of the NA of output beams of fiber lasers 12, 14, and 16, on the corresponding lens segment. Here the projections are arranged to be contiguous for minimizing displacement δ.

In this embodiment, the three optical fibers carrying the laser radiation are arranged so that the axis of the output beams exiting the ends of the fibers are parallel. Further, the ends of the fibers are arranged on the three points of an imaginary equilateral triangle.

One method of constructing composite lens 20 is to fabricate three circular lenses which are then cut with straight sides (edges) at 120° to each other to form the segments. Juxtaposition of the segments is such that the straight edges of the segments meet on the geometric-axis of the composite lens. The segments can then be bonded together or held together in a mechanical frame, whichever is convenient. It is also possible to make the composite lens as a single element. Segmented lens arrays in a single element can be generated by Power Photonic Ltd, of Dalgety Bay UK.

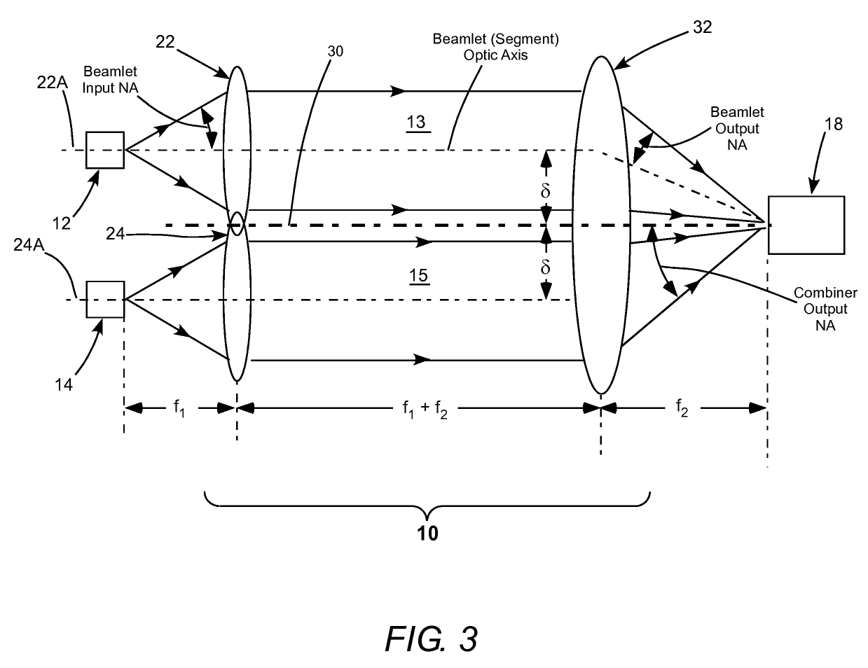

FIG. 3 is a side-elevation view schematically illustrating general dimensions and beam-parameters in the beam-combiner apparatus of FIG. 1. These dimensions and parameters are referred to in a description of optimizing the design of the inventive apparatus provided hereinbelow. Depicted beamlet-diameter, and beamlet divergence and convergence are greatly exaggerated for convenience of illustration. Only lens segments 22 and 24 of the composite lens and corresponding fiber lasers 12 and 14 are depicted.

The lens segments are spaced from the fiber-lasers by a distance f₁, which is about the focal length of the lens segments. Accordingly the beams are collimated by the assembly centered on the optic-axes of the lens segments. The optic-axes are parallel to the geometric axis 30 of composite lens 20. Transport fiber 18 is spaced apart from focusing lens 32 by a distance f₂ which is about focal length of lens 32. The composite and focusing lenses are preferably spaced apart from each other by a distance of about f₁+f₂. Also depicted are the beamlet input NA, i.e., the fiber output NA), the beamlet output NA, and the combiner output NA. The NA of a diverging or converging beam, as is known in the art, is the Sine of the convergence or divergence half-angle. Exemplary NA values specified herein are assumed to be measured at the 1/e² points of a beam.

An initially discouraging aspect of the inventive combiner arrangement, evident from the illustration of FIG. 2 is that the beam parameter product (BPP) of the combined focused beamlets is greater that the BPP that could be obtained by focusing the output beam from a single fiber. Generally the smaller the BPP the more effective a cutting operation can be for a given output power. Minimizing BPP is usually considered paramount in the design of prior-art delivery apparatus laser cutting operations. The BPP is the product of a laser beam's divergence angle (half-angle) and the radius of the beam at its narrowest point (the beam waist). The BPP quantifies the quality of a laser beam, and how well it can be focused to a small spot.

In order to quantify the consequences of this BPP increase, an extensive study was performed of the interdependence of the various parameters depicted in FIG. 3. The study was extensive inasmuch as there is no closed form equation that will describe the behavior of the beam-combining apparatus.

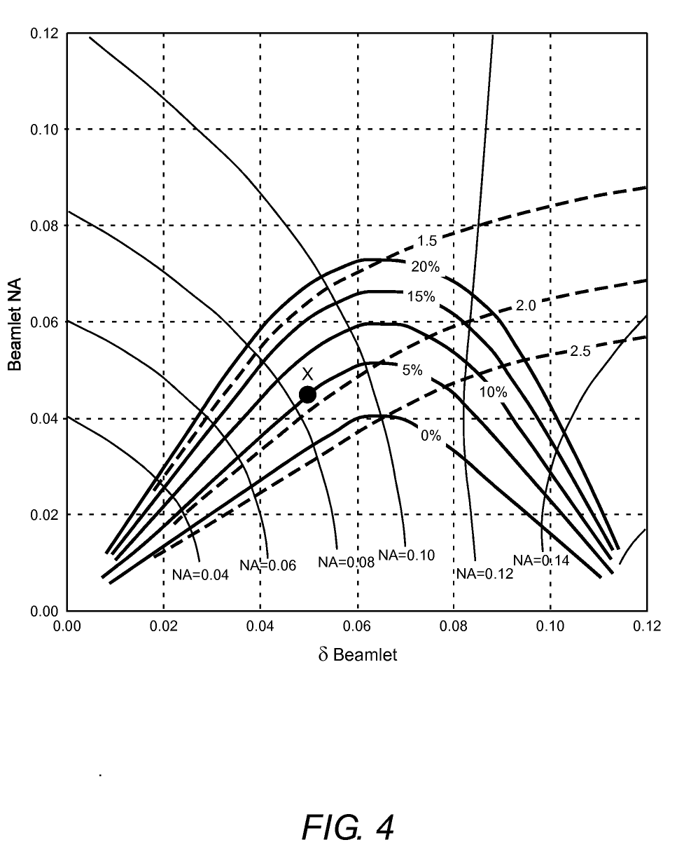

FIG. 4 is a graph schematically illustrating coupling losses, output numerical NA (fine solid lines) and BPP-ratio (bold dashed lines) of combined beams, and combining losses (bold solid lines) as a function of the displacement of the optic axes and the NA of individual focused beams in the combination thereof in the apparatus of FIG. 1. The BPP-ratio is the ratio of the BPP of the combined beams delivered into fiber 18 to the BPP for an individual focused beamlet. It was determined that if this ratio could be kept at about 2 or less, the inventive beam-combining would be effective in most contemplated cutting operations.

In the graph, black dot X is located at a BPP-ratio of about 1.9, with combining losses of only about 95%. Here, the beamlet NA is about 0.045 with optical axes of the beamlets located on a circle of radius (δ) equal to about 0.05 mm about geometrical axis 30 of composite lens 20. The NA of the focused beams is about 0.09.

The graph indicates that a compromise is necessary between BPP-ratio and throughput. High throughput (low losses) comes at the expense of large increase of BPP. A small BPP increase comes at the cost of large losses. Black dot X represents a good compromise, where the losses are 5% and the increase in BPP (BPP ratio) is 1.9. High throughput is obtained by selecting a low value for the ratio of the output NA to displacement δ, so as to avoid clipping a beam into the “wrong” lens-segment, but a high value of δ increases the divergence of the combined output beam and the BPP-ratio.

While the present invention is described above in terms of combining the outputs of three fiber-lasers, in principle it is possible to combine the outputs of four fiber lasers using a four-segment lens assembly, five fiber lasers using a five segment assembly, and so on. In order to do this however, the radius δ of the circle on which the optic axes of the segments are arranged would need to be progressively increased with the number of fibers and segments. The above-discussed parametric analysis of FIG. 4 indicates, however, that increasing delta would increase the BPP ratio.

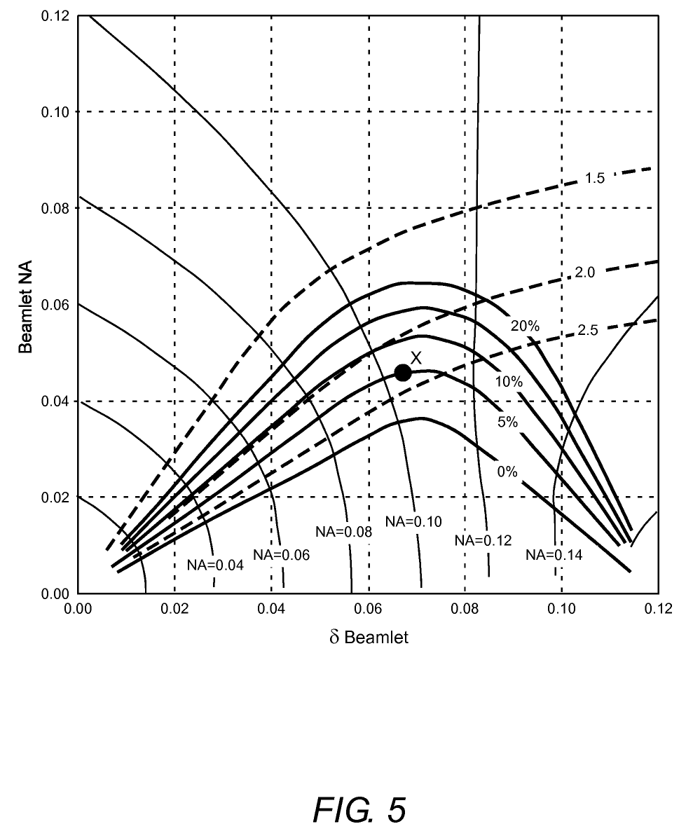

FIG. 5 is a graph similar to the graph of FIG. 4 but with parameters calculated assuming that the outputs of four fibers are combined using a four-segment lens. The black dot Y on the 5% loss contour is at a BPP increase (ratio) of about 2.3.

Here, the beamlet NA is again about 0.045 but with optical axes of the beamlets located on a circle of radius (δ) equal to about 0.067 mm about geometrical axis 30 of composite lens 20. The NA of the focused beams is about 0.105.

The BBP increase of 2.3 is near a margin of usefulness. A similar analysis for combining the outputs of 5 fiber-lasers with a five-segment lens requires a BPP increase of 2.6 to restrict losses to 5% with a loss of brightness (Power/BPP²) of 30%. This is probably too high a penalty to pay for the beam-combination.

In summary, the present invention is described above in terms of a preferred and other embodiments. The invention however is not limited by the embodiments described and depicted herein. Rather the invention is limited only by the claims appended hereto.

1. Optical apparatus, comprising:
three fiber lasers each thereof emitting a diverging beam from an output end thereof, each of said beams having a first numerical aperture, and with the output ends of the fiber lasers being arranged on three points of an imaginary equilateral triangle;
a transport optical fiber;
a collimator assembly including three juxtaposed spherical lens-segments each thereof having an optical-axis and arranged about a geometric axis of the collimator assembly, the optical-axes of the lens segments and the geometric-axis of the collimator assembly being parallel to each other, with the optical-axes of the lens-segments arranged on a circle having a radius centered on the geometric-axis of the collimator assembly, and each of the optical fibers being aligned with the optical axis of a corresponding one of the lens segments such that the diverging beams of the fiber lasers are collimated by the collimator assembly; and
a focusing lens arranged to focus the collimated beams, combined, into the transport optical fiber, the combined focused beams having a second numerical aperture.

2. The apparatus of claim 1 wherein the second numerical aperture is greater than the first numerical aperture.

3. The apparatus of claim 2, wherein each of the lens segments has two straight edges at an angle of 120 degrees to each other, with the segments juxtaposed such that the straight edges thereof join on the geometric-axis of the collimator assembly.

4. The apparatus of claim 3, wherein the first numerical aperture of about 0.045, the radius of the circle on which the optical-axes of the lens-segments are located is about 0.05 millimeters, and the second numerical aperture is about 0.09.

5-6. (canceled)

7. The apparatus of claim 1 wherein the beam parameter product (BPP) of the combined and focused beams is less than 2.0.

8. Optical apparatus, comprising:
three optical fibers carrying laser radiation and arranged so that the axis of the output beams exiting the ends of the fibers are parallel, and with the ends of the fibers being arranged on the three points of an imaginary equilateral triangle;
a compound collimator assembly including three collimating partial spherical lens segments, the optical axes of three lens segments being aligned with the output beams of the optical fibers for collimating the beams;
a transport optical fiber; and
a focusing lens arranged to combine and focus the collimated beams into the transport optical fiber.

9. The apparatus of claim 8, wherein each of the lens segments has two straight edges at an angle of 120 degrees to each other, with the segments juxtaposed such that the straight edges thereof join on the geometric-axis of the collimator assembly.

10. The apparatus of claim 8 wherein the beam parameter product (BPP) of the combined and focused beams is less than 2.0.
